(19) United States
(12) Patent Application Publication
(10) Pub. No.: US 2010/0257529 A1
(43) Pub. Date: Oct. 7, 2010

(54) Efficient systems and methods for consuming and providing power

(76) Inventors: Christopher Wilkerson, Portland, OR (US); Ming Zhang, Portland, OR (US); Wei Wu, Portland, OR (US)

Correspondence Address: INTEL CORPORATION;c/o CPA Global, P.O. BOX 52050, MINNEAPOLIS, MN, 55402, US

(21) Appl. No.: 12/384,501

(22) Filed: Apr. 6, 2009

(51) Int. Cl. G06F 9/46; H02J 7/35

(52) U.S. Cl. 718/102; 320/101; 718/100; 713/340

(57) ABSTRACT

With some embodiments, task processing based on power availability is provided for mobile computing platforms including laptops, tablets, netbooks, cell phones, as well as for other devices or systems that are not mobile such as desktop computers and server systems.

### TECHNICAL FIELD

The present invention relates generally to electronic devices and/or computing systems and in particular to platform management.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a an electronic device platform in accordance with some embodiments.

FIG. 2 is a flow diagram of a routine for processing tasks in accordance with some embodiments.

FIG. 3 is a diagram of a an electronic device platform in accordance with additional embodiments.

FIG. 4 is a diagram of a power source for electronic device platforms in accordance with some embodiments.

FIG. 5 is a diagram of a power source for electronic device platforms in accordance with additional embodiments.

FIG. 6 is a diagram of a power source for electronic device platforms in accordance with yet additional embodiments.

### DETAILED DESCRIPTION

With some embodiments, task processing based on power availability is provided for mobile computing platforms including laptops, tablets, netbooks, cell phones, as well as for other devices or systems that may not be mobile such as desktop computers and server systems. In systems with power harvesting capabilities (e.g., solar, wind, etc.), to allow direct supply of harvested power to the platform, task scheduling can take into account which power sources are able to deliver power. Using power availability in scheduling decisions, opportunistic scheduling, can allow for energy, harvested or otherwise, to be efficiently utilized.

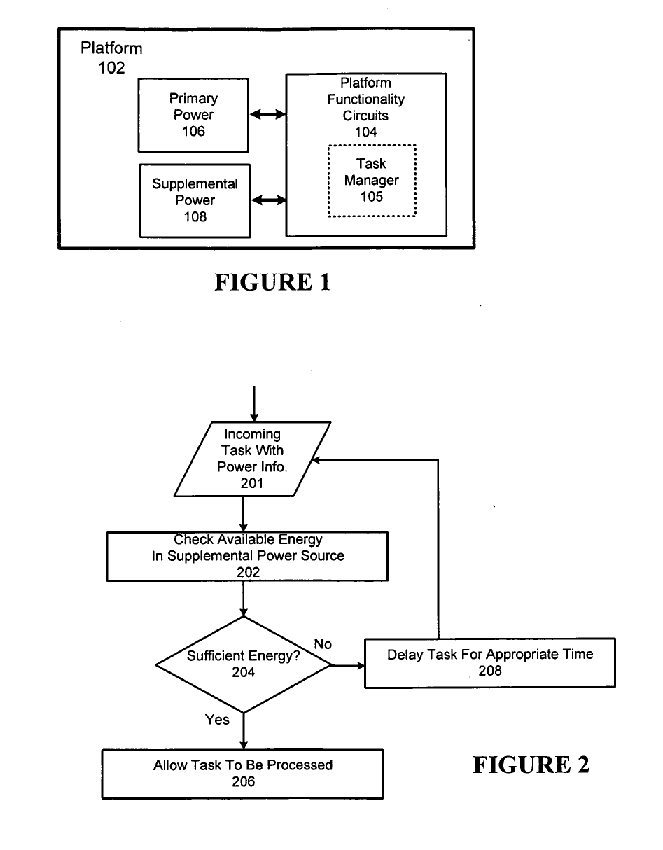

FIG. 1 is a block diagram of a portion of an electronic device platform 102 in accordance with some embodiments. The platform 102 may be for any electronic device, e.g., that uses a mobile power source or otherwise. It comprises platform functionality circuits 104, a primary power source 106, and a supplemental power source 108. The functionality circuits 104 correspond to one or more components such as integrated circuit (IC) chips, displays, and the like, with circuits for performing electronic device functions. For example, with a portable computing device, they may include a display device and one or more chips for implementing processor, hub, I/O, communications, and platform control functionality. Functionality circuits 104 comprise a task manager 105 to manage when tasks may be performed. It may not be the platform's exclusive task manager, but it schedules or at least participates in deciding when tasks, e.g., application tasks such as email, video download, etc., are processed. The task manager 105 may be in any part of a platform including its main processor, platform controller, hub, network interface device(s), or the like.

The primary and supplemental power sources 106, 108 provide power to the platform circuits when in operation. Each power source may be a mobile power source. Typically, the primary source 106, over time, will supply most of the electronic energy to the functional circuits. The primary source may comprise any suitable power source such as a battery, fuel cell, or the like. The supplemental source may store less overall energy but will typically be able to efficiently store and source electrical power to supplement the primary source, for example, at times when the primary source cannot provide sufficient power on its own. The supplemental source may also be employed when it has available power and tasks are available (e.g., via scheduling, interrupt, etc.) for processing to take advantage of the available power. This latter situation may be used to exploit energy harvesting, e.g., via solar, wind, or other energy sources, to charge the supplemental source.

The supplemental power source 108 may comprise any suitable device such as one or more capacitors, e.g., one or more so-called ultra capacitor (ultracap or supercap). Ultra capacitors are typically able to store a considerable amount of energy, at least when compared to other capacitors. They may not store much energy, as compared with a primary source battery, but they can efficiently be charged and re-charged to not only store harvested energy, e.g., from photo-voltaic solar cells, but also, they can generally provide a decent amount of power, albeit for a relatively small amount of time, to augment the primary source at times when large amounts of power is demanded. For example, a portable computing device may have average power demands of between 5 and 20 W but have peak, intermittent burst demands of up to 75 or 100 W. So, instead of using a primary source capable of sourcing 75 to 100 W, a smaller battery (e.g., 25 or 30 W) could be used as a primary source and an ultracap (e.g., 0.5 F ultracap capable of sourcing 75 W for up to 0.1 Sec. or 7.5 W up to 1 Sec.) could be employed as a supplemental source to provide additionally needed power during surge or spike periods. (It should be appreciated that the term ultracap is meant to encompass one or more capacitors, ultracap or otherwise and may even comprise other charge storage devices.)

FIG. 2 shows a portion of a scheduling routine, e.g., to be performed by a task manager 105, in accordance with some embodiments. At 201, the routine receives a task (or task information), e.g., any task such as an application task to be performed or otherwise processed by the functional circuits. The task information may include power information indicating how much power and/or energy may be needed for it to be processed.

At 202, the routine checks to determine how much power and/or energy is available in the supplemental power source 108. At 204, it determines if there is enough available power/energy in the supplemental source for processing the task. If not, then at 208, the processing of the task is delayed for an amount of time before returning back to 201 for processing. For example, it may delay the task for a sufficient duration so that it can be processed or performed at a later time when it is more likely that the supplemental source will have additional energy. It may be delayed to later be re-checked (e.g., at 304), or rather than going back to 301 as shown in the diagram, it may be scheduled for processing at a specified later time or within a specified window of time.

Scheduling may be course (e.g., in terms of one or more hours) or fine (in terms of minutes, seconds, or even smaller time increments). Fine grained scheduling may permit a restricted form of task rescheduling. Consequently, fine grained scheduling may have little impact on the user experience. For example, if a system delays e-mail synchronization by a second, the user will be unlikely to notice. However, since the task rescheduling is finer grained, there may be less flexibility to exploit a supplemental source. In contrast to fine grained scheduling, coarse grained scheduling re-schedules tasks, in such a way that the user might notice that the task has been rescheduled. For example, when considering e-mail synchronization, the user may notice that his/her e-mail hasn't been scheduled over the last hour as opposed to the last second. However, since coarse grained scheduling allows rescheduling over greater distances in time, the number of periods with available power will typically be greater, increasing rescheduling opportunities.

Returning back to decision 204, if there is sufficient energy available in the supplemental source, then it goes to 206, and the task is allowed to be processed. A task at 201 may arrive in any suitable manner. It may be part of a larger scheduling routine, within or external to a platform operating system, or it may come as a result of its being placed on a queue or as a result of a time-out condition. Alternatively, it could come from an interrupt. For example, an asynchronous interrupt scheme could be employed. The interrupt could indicate when energy was available to allow the execution of an interrupt service routine that could schedule tasks to take advantage of energy availability. For example, the interrupt service routine could be implemented in the OS to allow the operating system to control the rescheduling of tasks, or it could be implemented in firmware, e.g., with the operating system building a pool of task descriptors to allow the transparent scheduling of tasks.

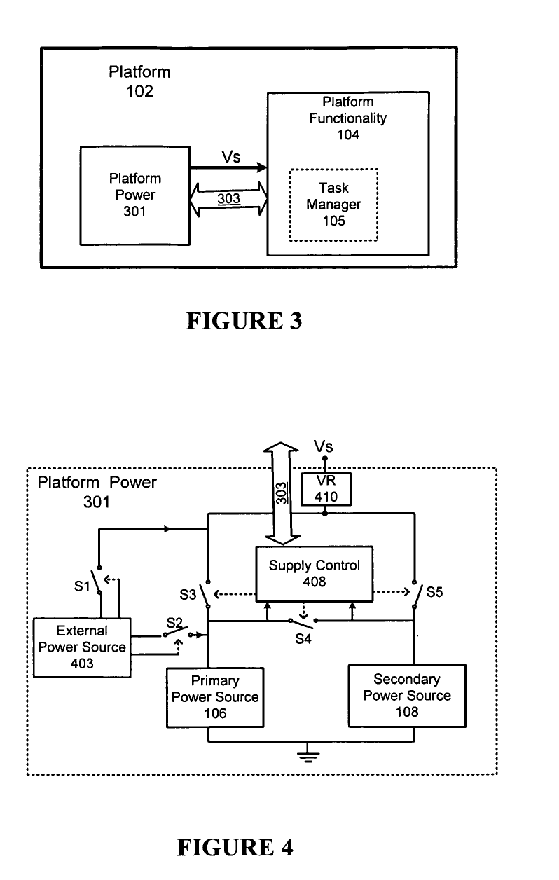

FIG. 3 shows another embodiment of a platform 102. It comprises functional circuits 104, with a task manager 105, and a platform power source 301 to provide it with power. The platform power source 301 provides it with a voltage supply (Vs) and communicates with the functional circuits via a link 303. The platform power 301 has primary and supplemental sources (not shown in this drawing), as discussed above. Through the link 303, it conveys to the task manager 105 how much power/energy may be available. This includes conveying direct information (e.g., power, energy, power duration, etc.) or indirect information that may allow a task manager to determine or estimate available energy. For example, it may convey a supplemental voltage level corresponding to a charge level or charge level range. The link may also convey instructions from the task manager 105 to the platform power source 301, e.g., to activate a supplemental source, as well as to request charge information, status, and the like. The link may be implemented in any suitable way. It could be analog and/or digital, and it could comprise multiple signal lines, or it could be implemented as a serial link.

FIG. 4 shows a platform power source 301 in accordance with some embodiments. It comprises a primary source 106 and a supplemental source 108, as discussed above, along with external power source 403, a supply control circuit 408, voltage regulator (VR) 410, and switches, S1 to S5, coupled together as shown. The external power source 403 provides power to charge primary source 106, e.g., it may be an AC adapter when primary source 106 is a battery or battery module. The switches may be implemented with any suitable circuit elements including transistors, analog switches, and the like. They allow the supply control circuit 408 to isolate and/or couple together the primary and sources, from and to each other, as well as to/from the external source and the input of VR 410, which provides a regulated supply Vs for the functional circuits.

The supply control circuit 408 may decouple the supplemental source from the primary source in order to measure or otherwise check its charge level. On the other hand, it may couple it to the primary source in order to charge the supplemental source, e.g., during a time when relatively low power is required at Vs or it could be coupled to the primary source when the external power source is engaged. When increased power is required or when tasks, e.g., scheduled tasks, are available for processing, both the primary and supplemental sources may be coupled to source Vs through S3 and S5, with our without S4 closed.

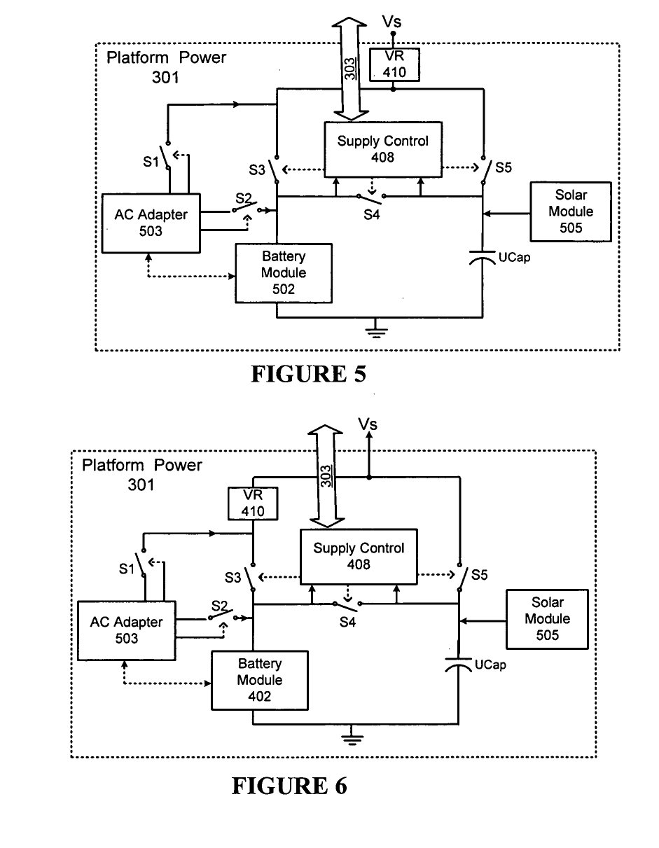

FIG. 5 shows another embodiment of a platform power source 301. In this embodiment, a battery module 502 is specifically employed as a primary power source, and an ultracap (UCap) is used as the supplemental source. An AC adapter 503 is employed for providing external power to the primary source (battery module), and directly to the functional circuits. It also may be used to charge the supplemental source (UCap). A solar module 505 is also provided to charge the UCap. It may comprise, for example, one or more photovoltaic cells to supply electricity to charge the UCap.

In this embodiment, the solar module may directly charge the UCap, thereby reducing losses that may otherwise occur from charging a source like a battery through battery charge circuitry, etc. This may be helpful because power generated by energy harvesting components (wind, solar, etc.) is less reliable and discontinuous, when compared to the power supplied by a battery. The productivity of a solar panel is a function of the intensity and type of light that is available. For example, there may be a factor of 100 difference between the power generated by solar cells outdoors under direct sunlight and that generated indoors under fluorescent light. In addition, both outdoors and indoors lighting intensity will change when the user passes by a shadow. Accordingly, power availability aware scheduling, e.g., allowing both fine grained and coarse grained scheduling of tasks to coincide with higher energy availability may be employed.

The supply control circuit may have circuitry to monitor the UCap to know the extent to which it is charged. For example, it may comprise a voltage detection device to detect (measure, estimate, etc.) the voltage at the UCap in order to assess how much power and/or energy may be available. it may also have logic to predict or otherwise determine when energy will be available. for example, it may evaluate charge patterns with present state conditions to predict when and how much energy will be available. This information could be used by a schedule manager in the functional circuits in scheduling tasks to be performed when the UCap is sufficiently charged.

FIG. 6 shows yet another embodiment of a platform power source 301. It is similar to the power source of FIG. 5 except that the VR 410 is coupled between the primary and supplemental sources and thus, the supplemental source is coupled directly to the Vs supply node to provide it with power. This may be useful, for example, in environments where the primary source (e.g., battery) supplies a reasonably higher voltage supply than Vs provided to the functional circuits. The supplemental source, e.g., UCap, may be used to directly supply a voltage to the circuits. Ultra capacitors, like most capacitors, can be charged to voltages within a range and can be selected to operate efficiently at high as well as low voltages. so, a relatively small voltage UCap may be employed and charged to a voltage level sufficiently low for Vs and at the same time, it may store a reasonable amount of energy. Such an implementation may be beneficial in various different ways. For example, when functional circuits are in a low power (e.g., sleep, standby, etc.) state, the ultracap may be used to supply their power without the need for the battery, thereby removing the use of a VR, which may be inefficient, especially when low power is being supplied. In addition, the ultracap could be used to supply the circuits during a so-called “hot” battery swap to replace the primary source without having to shut down all of the functional circuits. In some embodiments, multiple ultracaps may be used in different configurations. For example, some could be upstream and some downstream of a voltage regulator.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An electronic device, comprising:
functional circuits to process tasks;
a primary power source to supply power to the functional circuits; and
a supplemental power source to supply power to the functional circuits to process one or more tasks identified for processing when sufficient energy is available in the supplemental power source.

2. The device of claim 1, in which the one or more tasks are identified based on energy required for their being processed.

3. The device of claim 2, in which the one or more tasks are identified based on deadline information.

4. The device of claim 1, in which the primary power source includes a battery.

5. The device of claim 4, in which the supplemental power source includes an ultra capacitor.

6. The device of claim 5, in which the ultra capacitor is to be charged by at least one of the battery and an adapter.

7. The device of claim 6, in which the ultra capacitor is to be charged via energy harvesting.

8. The device of claim 7, in which energy harvesting comprises charging the ultra capacitor with at least one solar cell.

9. The device of claim 1, comprising a voltage regulator between the primary and secondary power sources.

10. A computer system, comprising:
a chip with a processor to process tasks with information to indicate their energy requirements;
a supplemental power source to provide power to the processor, the tasks to be scheduled for processing when sufficient energy is available in the supplemental power source.

11. The system of claim 10, comprising one or more solar cells to charge the supplemental power source.

12. The system of claim 11, in which the supplemental power source comprises an ultra capacitor.

13. The system of claim 10, comprising a power control circuit to monitor available energy in the supplemental power source and to cause it to be coupled to the processor.

14. The system of claim 13, in which the power control circuit is to initiate an interrupt when sufficient energy is available in the supplemental power source for tasks to be processed.

15. The system of claim 13, in which the power control circuit is to couple the supplemental power source to the processor in response to a request from a task manager.

16. The system of claim 15, in which the task manager is part of the processor.

17. A method, comprising:
in a chip, identifying energy to be consumed for processing a task; and
causing the task to be processed when sufficient energy is available in a supplemental power source.

18. The method of claim 17, comprising monitoring the supplemental power source to determine when sufficient energy is available for processing the task.

19. The system of claim 18, comprising interrupting a task processor when sufficient energy is available in the supplemental power source.
